(19) United States
(12) Patent Application Publication
(10) Pub. No.: US 2012/0129616 A1
(43) Pub. Date: May 24, 2012

(54) Constant Velocity Joint and Drive Shaft

(75) Inventor: Claus Disser, Seligenstadt (DE)

(73) Assignee: BF New Technologies GmbH, Muhlheim (DE)

(21) Appl. No.: 13/319,084

(22) PCT Filed: Apr. 28, 2010
(86) PCT No.: PCT/EP2010/002605

§ 371 Date: Feb. 13, 2012

(30) Foreign Application Priority Data
May 8, 2009 (DE) 20 2008 006 696.7

(51) Int. Cl. F16D 3/223

(52) U.S. Cl. 464/145

(57) ABSTRACT

The invention relates to a constant velocity joint having an inner race (3), an outer race (4), a journal (9) that can be connected with the outer race for connecting the joint and with a reinforcement ring (7), that can be positively connected with the outer race, which encases the outer race (4) in torque-proof manner and has at least one stop section (7a, 7b), which defines the position of the outer race (4) in the reinforcement ring (7) in a first axial direction. The journal (9) has a flange-like shoulder section (8), for example, with an axial stop surface (8a), which defines the position of the outer race (4) in the reinforcement ring (7) in a second axial direction that is opposite to the first axial direction, whereby the journal (9) is fixated on the reinforcement ring (7).

The invention relates to a constant velocity joint which can be used in longitudinal or lateral shafts of vehicles. A constant velocity joint of this type has an inner race, an outer race and a reinforcement ring that can be positively connected with the outer race, which encases the outer race in torque-proof manner. In addition, the reinforcement ring may have a stop section that defines the position of the outer race in the reinforcement ring in a first axial direction.

A drive shaft designed as lateral shaft with two so-called UF joints is known, for example, from DE 102 20 715 A1. The two joints of this lateral shaft are different, whereby both joints have a massive, bell-shaped outer race that is formed integral with a journal for connecting the joint. Due to this design of the joints, the entire lateral shaft is comparably heavy. Further, DE 199 38 771 C2 also shows a lateral shaft with UF joints that unfavorably influence the static mass in vehicles, because of their significant weight.

From DE 196 09 423 A1, a lateral shaft for use in, for example, a rear axle of a vehicle is known. The joints of this lateral shaft are designed for comparably small articulations in operation. For the front axle, such a shaft is unsuitable, as in operation, larger articulation angles of the joints are required.

In principle, it is currently customary to provide joints that respectively correspond to the individual use in longitudinal, as well as in lateral shafts of vehicles.

In an all-wheel-drive vehicle it is therefore the case most of the time that not only the joints at the longitudinal shaft are different from each other, but also that these are different from the joints used in the lateral shafts. Even among themselves, the lateral shafts for the front axle and the rear axle are not constructed the same way, and the joints used in a lateral shaft are also adapted to the different requirements. In this way it is possible to use the joints and shafts that are optimal for the respective purpose, for example, on the front axle lateral shafts having larger operational articulation angles, and at the rear axle, lateral shafts with small operational articulation angles. In addition, by using slip joints, at least sometimes, the slip units integrated into the shaft sections can be dispensed with.

On the other hand, it is the objective of the present invention to provide a constant velocity joint and a drive train for a motor vehicle that is optimized with is respect to production costs and with respect to weight distribution, in particular by considering the static masses.

This problem is solved by the constant velocity joint of the type cited at the beginning, for example, thereby, that the journal has a shoulder section that can, if necessary, be designed like a flange, with an axially located stop surface, which defines the position of the outer race in the reinforcement ring in a second direction that is opposite to the first axial direction, whereby the journal is fixated at the reinforcement ring. In other words, the reinforcement ring surrounds the outer race in such a way that a torque-proof and fixed housing of the outer race is achieved in axial direction in the reinforcement ring. The outer race can thus only be pulled away from the stop section in the reinforcement ring and can be connected against it. The fixation of the outer race in the reinforcement ring takes place via the shoulder section of the journal, which is connected to the outer race, whereby it is pressed against the stop in the reinforcement ring. After inserting the outer race and the shoulder section of the journal into the reinforcement ring, the outer race is thus fixated in the reinforcement ring. To prevent a detachment of the shoulder section of the journal from the reinforcement ring, the shoulder section of the journal can be welded together with the reinforcement ring, or be connected in another suitable way, in particular by material engagement.

The production of such a joint can consequently take place according to the invention by making a reinforcement ring available in which first the outer race and subsequently the shoulder section of a journal are inserted in such a way that the shoulder section of the journal connects the outer race to a stop section of the reinforcement ring. Due to the firmly bonded material connection between the reinforcement ring and the shoulder section of the journal, the joint is produced without requiring any deformation steps during assembly.

Independent of the previously cited features, has been shown to be particularly advantageous, if in a constant velocity joint with an inner race, an outer race and a reinforcement ring that can be positively connected with the outer race, which encases the outer race torque-proof, the outer race consists of a tempered material, for example, sheet metal, while the reinforcement ring consists of a non-tempered sheet metal, that is preferably softer compared to the outer race. This not only affords significant advantages relative to the production costs, as only the outer race must be tempered and not, as is the case in prior art, comparably thick-walled component parts, instead tempering of the reinforcement ring can be eliminated. In operation, this means that upon torque impulses, the comparably thin-walled outer race can elastically deform to a small degree, whereby the softer reinforcement ring can absorb this deformation of the outer race. Cracks or similar damage of the reinforcement ring are thus of no concern upon torque impulses of this type. In this manner, a constant velocity joint is created that can not only be produced cost-effectively and has a low weight, but which also has significant advantages with respect to known joints.

Conventional joints are sealed by a sealing boot, so that no dirt can ingress into the joint and/or grease discharge from it. This sealing boot is, for example, fastened at the outer race or at a reinforcement ring and fastened with a shaft that can be connected with the inner race. Usually, amounts of grease of approximately 70 to approximately 120 g are placed in joints that are used for passenger vehicles, in order to grease the joint for the duration of its life cycle. However, this grease is often not compatible with the material of the sealing boot. In addition, the comparably large amount of grease that must respectively be accelerated or braked, negatively influences the properties of the joint.

Independent of the previously cited features, a joint according to the invention differentiates itself thereby, that in addition to the sealing boot a grease barrier, for example, designed like a disk is provided. According to the invention, this grease barrier that consists of an elastically deformable material is located in the reinforcement ring and is fixated sealing on it or at a shaft connected with the inner race. The free edge of the grease barrier, i.e. the radial inner edge when the grease barrier is fixated at the reinforcement ring, preferably abuts sealing at the shaft, or in the reverse case, at the reinforcement ring. In this manner, even when the joint is articulated, the discharge of grease from the direct joint section is prevented. Consequently, only a comparably small section of the joint must be filled with grease, in order to ensure sufficient lubrication for the life of the joint.

The comparably large section enclosed by the sealing boot can thereby, remain free of grease. This achieves not only a significant weight reduction, but the material of the sealing boot is also significantly less affected by the sometimes aggressive grease. In the joint according to the invention, 40 to approximately 50 g of grease are sufficient to lubricate the joint.

According to a further aspect of the invention, in a constant velocity joint having an inner race, an outer race and a reinforcement ring, the length of the reinforcement ring in the axial direction of the joint is larger by approximately a factor of 1.5 to 2.5 than the length of the outer race in the axial direction of the joint. In particular, the length of the reinforcement ring is larger by approximately a factor of 1.7 to 2 than the length of the outer race. In this way, a section of the reinforcement ring protruding over the outer race is created, at least in axial direction. This can be either a connection section for fastening a journal and/or preferably a cylindrical gasket section that can be used for fastening a grease barrier and/or a sealing boot. Thus, in this joint according to the invention, the reinforcement ring satisfies several objectives so that the total number of the component parts of the joint can be kept small.

Of course, the previously described four groups of features can be realized independent of each other, or in any combination in a joint, without thereby digressing from the subject matter of the invention.

In a refinement of these inventive ideas it is provided, that in a joint having a journal that can be connected with the outer race for connecting the joint, this journal has, at least in sections, an outer contour that transmits torque, which corresponds with the inner contour of the reinforcement ring.

Consequently, the torque is not transmitted exclusively by, for example, the firmly bonded connection between the journal and the reinforcement ring, but essentially through the positive connection of these two component parts.

According to a preferred embodiment of the invention, the reinforcement ring has at least one shoulder extending approximately perpendicular to the longitudinal axis of the joint radially inward, which forms a stop section for positioning the outer race. In a constant velocity joint designed as counter track joint, additional stop sections are provided for positioning the outer race on top of that, already by the track contours in the outer race that widen or taper in various directions when the design of the reinforcement ring is correspondingly adapted.

In a constant velocity joint designed with a grease barrier located in the constant velocity joint, the grease barrier advantageously has an outer bead section, for example, reinforced by a ring or a band, which is pressed into the reinforcement ring. This bead section is advantageously designed approximately sleeve-like, so that a large contact surface for sealing with the reinforcement ring is present. In contrast, the main direction of extension of the grease barrier is, in the unarticulated joint, approximately perpendicular to this bead section and thus perpendicular to the longitudinal axis of the joint.

It is especially preferred when the joint is a fixed joint, in particular a counter track joint, that has a cage between the inner race and the outer race having balls guided by it for transmitting torque.

The components of the joint are preferably configured for transmitting continuous torque of more than 400 Nm, in particular, more than 550 Nm, or impulse moments of, for example, 4,000 to 6,000 Nm. In other words, the joint in accordance with the invention is also suitable for large and powerful engines in passenger vehicles. It is thereby preferred that the configuration of the joint remains unchanged even when it is used in less powerful motorized vehicles, i.e. when the joint is, if anything, over dimensioned.

In order to keep the static mass of vehicles as small as possible, a joint according to the invention is designed in such a way that in particular due to the decrease in the thicknesses of the walls, at least of the reinforcement ring and/or the outer race, the weight of the joint consisting of inner race, cage, balls, outer race and reinforcement ring, weighs less than 1 kg, in particular less than approximately 600 g. At the same time, such a joint is to be configured for the transmission of continuous torque of more than 500 Nm, for example, 600 Nm. By way of example, the following table shows the advantageous weight-reduced design of the joint according to the invention compared with a conventional standard UF joint that has a massive outer part integrally connected with the journal and formed as outer race, and is used in this way in automotive engineering.

| | Joint according to the | | | |
|---|---|---|---|---|
| | invention | | UF Standard Joint | |
| Outer part | ~200 | g | ~2,200 g (incl. journal) | |
| Outer race | ~100 | g | | |
| Ball hub | ~170 | g | ~170 | g |
| Ball cage | ~40 | g | ~70 | g |
| Balls | ~48 | g | ~72 | g |
| Weight of joint | ~560 | g | ~2.5 | kg |
| Journal | ~780 | g | | |
| Grease | ~50 | g | ~75 | g |
| Total | ~1.4 | kg | ~2.5 | kg |

As illustrated in the table above, the invention not only has advantages with respect to the weight of the actual joint, but also, by considering a journal that can generally be adapted to different specifications in the invention, and provisions for the lubricating grease. Here, a weight reduction, in particular in the wheel area can be realized of ˜1 kg, which has an advantageous effect on vehicle safety, weight reduction as well as fuel consumption. In particular, due to the exchangeable connection structure of the journal and the actual joint, the present invention can be used modularly for various drive trains and connection systems to wheel and axle drive in a cost-effective way. Precisely also in drive trains that are configured for high performance, the joint according to the invention has the advantages cited above, as high torque must be accommodated, as a rule, with a larger and even heavier standard joint such as a UF 107.

To be able to use the joint according to the invention as widely as possible it is preferred when the joint has an admissible operating articulation angle of the outer race to the inner race of more than 30°, in particular, approximately 45°. The joint can thus be used in the front axle as well as in the rear axle, whereby the large admissible articulation angles in operation would not be mandatory in the rear axle.

Advantageously, the joint according to the invention can be designed in such a way that the reinforcement ring surrounds the outer race in sections and the outer race is simultaneously partially surrounded by the journal on the side of the journal. The reinforcement ring can have a protrusion for forming a stop surface for the journal and also surrounds, in the further direction on the side of the journal, likewise the journal. Likewise, the outer race, the journal and the reinforcement ring can ensure the transmission of high torque on account of corresponding torque-transmitting profiling, as the torque is transmitted by the outer race via the reinforcement ring, as well as directly onto the journal by the outer race.

The objective on which the invention is based is further solved by a drive shaft for a motor vehicle that has two constant velocity joints, at least one shaft pipe, and if necessary, a slip unit, whereby the two joints are constructed in the same way, in particular, identical, and each joint has an associated journal connectable with the outer race and/or the reinforcement ring for connecting the joint. Thereby, the joints can, in particular, be joints of the type cited above, i.e. joints that have an inner race, an outer race, a cage having balls located between these and a reinforcement ring having a positive connection with the outer race. Thereby, the joints can even be identical to the extent that the type of connection of the journal, for example, with a flange-like shoulder section, which determines, together with a stop surface, the position of the outer race in the reinforcement ring is the same, while only the design of the actual shaft journal is individually adapted to the respective connection, i.e. to a drive or differential or a wheel.

The use of such joints having the same construction offers significant cost savings potential. In particular, in complete or essentially complete machined production of the individual components of the joints, these can be produced very precisely and simultaneously cost-effectively. However, this only makes economic sense if these are also needed in large quantities, which can be achieved thereby that in the lateral shafts, identical joints are used instead of different joints.

In a refinement of this inventive idea it is provided that in a drive train for a motor vehicle having at least one longitudinal shaft and at least two lateral shafts that respectively have joints, all of these joints are constructed in the same way, in particular, are identical. Thus, in an all-wheel-drive vehicle, in the longitudinal shaft, for example, three identically constructed joints and additionally eight additional joints in the lateral shafts can be identically designed. In a sometimes provided additional intermediate shaft between the drive and a front axle differential, the number of identical joints in the drive train in this example is even increased to thirteen. All of these joints are then preferably fixed joints with a maximum operational articulation angle of approximately 45°.

Independent of the previously described features, a drive shaft according to the invention differentiates itself thereby, that the total weight of the two joints, i.e. the inner races, outer races, the cages having balls and the reinforcement rings together, is smaller than that of the at least one shaft pipe with the slip unit that is provided if necessary. In particular, the total weight of the two joints is smaller by approximately a factor of 5 than the total weight of the other shaft components.

The entire drive shaft thereby preferably has a weight of less than 6.5 kg when used in the rear axle or less than approximately 5.5 kg when used at the front axle. This is due to the comparably shorter shaft pipes when used at the front axle. Hereby the components of the shaft, and in particular, if the joints are configured for the transmission of continuous torque of more than 500 Nm, and have a permissible operational articulation of preferably approximately 45°.

In the following, the invention will be described in more detail with the help of exemplary embodiments and by referring to the drawing. Schematically shown are:

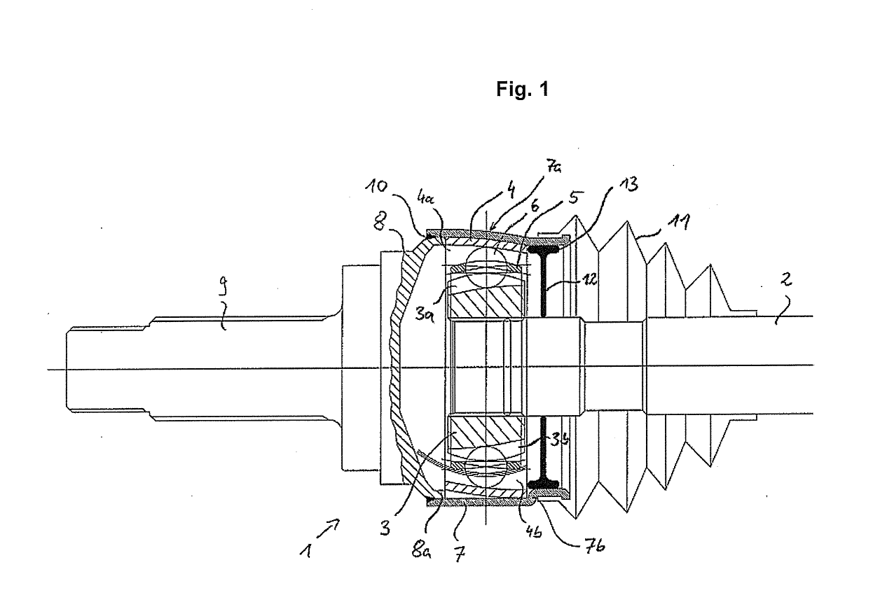

FIG. 1 a joint according to the invention in an elongated state in a partially cross-sectional lateral view;

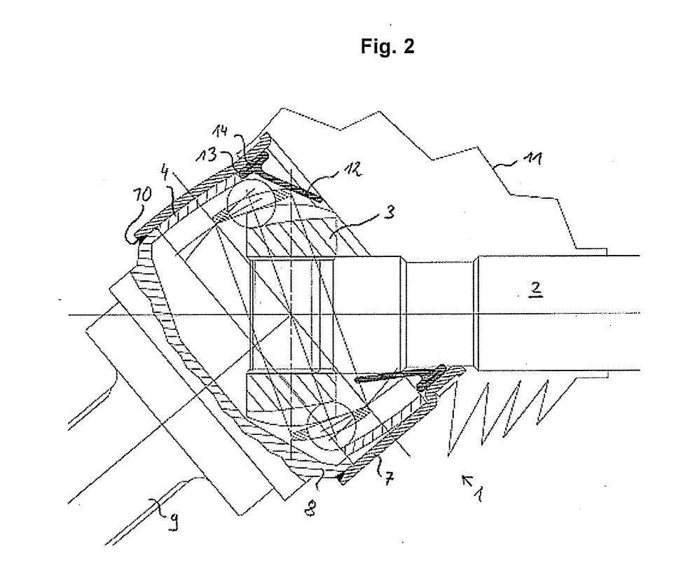

FIG. 2 the joint according to FIG. 1 in articulated state; and

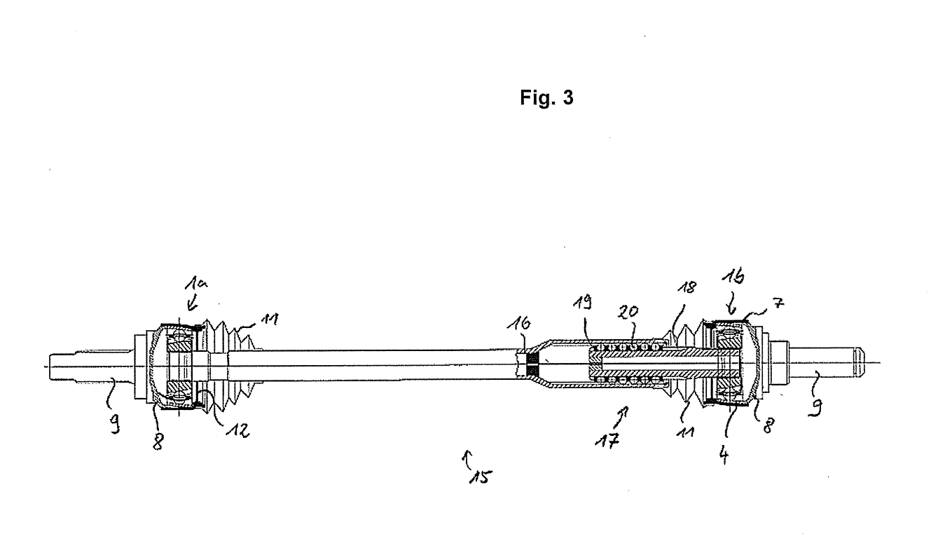

FIG. 3 a lateral shaft according to the invention in a partially cross-sectional lateral view with two joints according to FIGS. 1 and 2; and

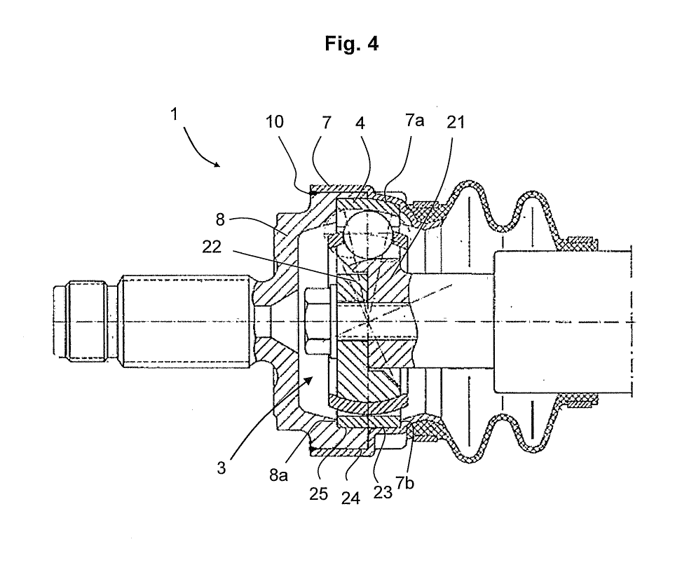

FIG. 4 a further variant of the joint according to the invention in a partially cross-sectional lateral view.

Joint 1, which is shown in the figures has an inner race 3 for connecting a shaft 2. Inner race 3 is encompassed by an outer race 4, whereby between inner race 3 and outer race 4 a cage 5 is guided in the windows of which balls 6 are housed for transmitting torque between inner race 3 and outer race 4.

Joint 1 is designed as counter track joint, i.e. as a fixed joint in which inner race 3 is retained by balls in axial direction, non-displaceable to outer race 4. For this, inner race 3 and outer race 4 are designed with tracks 3a, 3b, 4a, 4b, for housing balls 6. The pairs of tracks 3a, 4a; 3b, 4b of inner race 3 and outer race 4 that are associated with each other open in the same direction, i.e. the track base of the upper pair of tracks 3a, 4a in FIG. 1 approaches as seen in the figure, from left to right. Cage 5 is guided in outer race 4, whereby adjacent to outer tracks 4a, 4b in outer race 4, cage guide surfaces are provided.

Outer race 4 is encased by a reinforcement ring 7, whose inner contour is adapted to the outer contour of outer race 4. The assembly of outer race 4 in reinforcement ring 7 takes place by inserting outer race 4 in FIG. 1 from left to right into reinforcement ring 7. Corresponding to the contouring of the outer tracks 4a of outer race 4, reinforcement ring 7 has a profiled inner contour, that makes not only the transmission of torque between outer race 4 and reinforcement ring 7 possible, but also defines the axial position of the outer race in reinforcement ring 7. Reinforcement ring 7 thus forms, together with its inner profiling, a first stop section 7a for positioning outer race 4.

For tracks 3b, 4b that open in the other direction, such as illustrated, for example, in FIG. 1 on the bottom, reinforcement ring 7 has a saucer-shaped recess with constant cross section. Thus, in this section, outer race 4 in this section in FIG. 1, abuts only with the right facing side at a corresponding shoulder 7b of reinforcement ring 7, as a result of which likewise an axial positioning of outer race 4 in reinforcement ring 7 is achieved. Even shoulder 7b thus forms a stop section.

The position of outer race 4 in reinforcement ring 7 is further determined thereby, that flange-like widened shoulder section 8 of a journal 9 is inserted into reinforcement ring 7, and lies against outer race 4 with a facing-side stop surface 8a. As a result of weld connection 10 shown in the embodiment according to FIG. 1, between reinforcement ring 7 and the shoulder section of journal 9, outer race 4 is fixated in reinforcement ring 7. The shoulder section of journal 9 thereby has profiling corresponding to reinforcement ring 7, so that torque is transmitted from reinforcement ring 7 via the profile into shoulder section 8 of journal 9.

In the illustrated embodiment, outer race 4 and reinforcement ring 7 are designed as comparably thin-walled component parts. Hereby, according to a preferred embodiment, only outer race 4 is tempered in order to, in particular, be able to withstand the punctiform loads of balls 6 during the transmission of torque, whereas reinforcement ring 7 is not tempered and thus consists of a softer material compared to outer race 4. Potential small deformations of outer race 4 upon torque impulses can be absorbed by reinforcement ring 7 in this way.

The length of reinforcement ring 7 is significantly larger in axial direction than outer race 4. In this way for one, shoulder section 8 of journal 9 on the left side in FIG. 1, can be housed in a section of reinforcement ring 7 that protrudes axially beyond outer race 4. For another, in FIG. 1 on the right side, a cylindrical protrusion of reinforcement ring 7 is formed in sections opposite to outer race 4. On the one hand, it serves to fasten a sealing boot 11 on reinforcement ring 7, and on the other, sealing boot 11 is also fastened on shaft 2, in order to protect joint 1 from any ingression of dirt.

On the inner side of the cylindrical protrusion of reinforcement ring 7, a disk-shaped grease barrier 12 is inserted that consists of an elastic, deformable material. A sleeve-like bead section 13 of grease barrier 12, which can be reinforced with a band or a ring 14 (compare FIG. 2), is thereby clinched in reinforcement ring 7. The radial inner edge section of grease barrier 12 lies sealing against shaft 2. As can be seen in the view in FIG. 2, the disk-like section of grease barrier 12 deforms when the joint is elongated approximately perpendicular to the joint axis upon an articulation of the joint, whereby the grease barrier continues to lie against shaft 2 or inner race 3 or cage 5, in order to prevent any discharge of grease from the joint. Due to providing grease barrier 12, only a comparably small section of the joint, i.e. the section left of grease barrier 12 in FIG. 1, must be filled with grease in order to ensure sufficient lubrication of the components of joint 1 extending over their expected life cycle. In the exemplary embodiment according to FIG. 1, for example, approximately 40 to 50 g of grease are sufficient. However, the section in FIG. 1 that is also sealed by sealing boot 11 to the right of grease barrier 12, does not need to be filled with grease.

Lateral shaft 15 shown in FIG. 3 consists of two joints 1a and 1b of the type described before, as well as a hollow shaft 16, and a slip unit 17, that permits an axial elongation of lateral shaft 15. Slip unit 17 is formed by a flared sleeve section of hollow shaft 16, as well as by a journal 18 dipping into this sleeve that respectively have tracks extending in axial direction in which a cage 19 is guided with several sequential balls 20. Slip unit 17 thus exclusively permits an axial length adjustment of lateral shaft 15.

As can be seen in the illustration in FIG. 3, both joints 1a and 1b are identically constructed to the extent that inner races 3, outer races 4, cages 5, balls 6 and reinforcement rings 7 are constructed in the same way (identical). Even grease barriers 12 and the connection of the two sealing boots 11 is the same. Even the connection of journals 9 with shoulder areas 8 is the same in both joints 1a and 1b. At the most, they are different in the design of journals 9, which can be adapted to the respective installation conditions.

Lateral shaft 15 shown in the embodiment of FIG. 3 is configured for use in the front axle as well as in the rear axle of an all-wheel-drive vehicle with a maximum continuous torque of 580 Nm at an engine power of approximately 300 HP. The maximum angle of articulation during operation of each of joints 1a and 1b is 45°. The weight of lateral shaft 15 thereby amounts to a total of under 5.5 kg for the front axle and under 7 kg for the rear axle.

FIG. 4 presents an additional possible variant of the joint according to the invention. Analog to the first embodiment, joint 1 is executed as a counter track joint, however, in this embodiment, inner race 3 has two elements connected with each other that lie behind each other on the inner race axis and of which a first element 21 has the first inner ball races and a second element 22, the second inner ball races of joint 1.

Reinforcement ring 7, which is simultaneously designed for fastening sealing boot 11, encases outer race 4 directly in a first section 23, whereby reinforcement ring 7 and inner race 4 are designed with corresponding profiling analog to the first embodiment. A first stop section 7a ensures the positioning of outer race 4, while reinforcement ring 7 forms a saucer-shaped recess with constant cross section for the tracks pairs 3b, 4b opening in the other direction, and the outer race in this section lies against shoulder 7b of reinforcement 7b. Shoulder 7b forms the stop section, which likewise ensures axial positioning of outer race 4 in reinforcement ring 7. Simultaneously, the position of outer race 4 is ensured by journal 9 that has a protrusion for forming facing-side stop surface 8a, at which outer race 4 abuts. Weld connection 10 secures the axial fixation of the connection between reinforcement ring 7, outer race 4 and journal 9. Shoulder section 8 of journal 9 is, compared to the embodiment shown in FIG. 1, designed longer in axial direction, and also encases outer race 4 in a second section 24 in the way of an outer centering, whereby shoulder section 8 of journal 9 is also encased by reinforcement ring 7 in third section 25. Thereby, journal 9 and reinforcement ring 7 have corresponding profiling for torque transmission on the outer and the inner side, as a result of which torque is transmitted by outer race 4 directly to journal 9, and also via reinforcement ring 7.

Reference numbers:

| 1, 1a, 1b | Joint |
|---|---|
| 2 | Shaft journal |
| 3 | Inner race |
| 3a, 3b | Inner track |
| 4 | Outer race |
| 4a, 4b | Outer track |
| 5 | Cage |
| 6 | Ball |
| 7 | Reinforcement ring |
| 7a, 7b | Stop section |
| 8 | Shoulder section |
| 8a | Stop surface |
| 9 | Journal |
| 10 | Weld connection |
| 11 | Sealing boot |
| 12 | Grease barrier |
| 13 | Bead section |
| 14 | Band |
| 15 | Lateral shaft |
| 16 | Hollow shaft |
| 17 | Slip unit |
| 18 | Journal |
| 19 | Cage |
| 20 | Ball |
| 21 | First element |
| 22 | Second element |
| 23 | First section |
| 24 | Second section |
| 25 | Third section |

1. A constant velocity joint having an inner race, an outer race, a journal that can be connected with the outer race for connecting the joint and with a reinforcement ring that can be positively connected with the outer race, which encases the outer race torque-proof, and has at least one stop section that defines the position of the outer race in the reinforcement ring in a first axial direction, wherein the journal has, for example, a flange-like shoulder section having an axial stop surface that defines the position of outer race in reinforcement ring in a second axial direction that extends in the opposite axial direction to the first axial direction, whereby the journal is fixated at reinforcement ring.

2. A constant velocity joint, as recited in claim 1, having an inner race, an outer race and a reinforcement ring that can be positively connected with the outer race, which encases the outer race torque-proof, wherein the outer race consists of tempered sheet metal and the reinforcement ring consists of non-tempered sheet metal, which is preferably softer compared to the outer race.

3. A constant velocity joint, as recited in claim 1, having an inner race that is connected with a shaft when in operation, an outer race having a reinforcement ring that can be positively connected with the outer race, which encases the outer race torque-proof, and with a sealing boot to seal the constant velocity joint, which is fixated at the reinforcement ring and the shaft, wherein in the reinforcement ring, a preferably disk-like grease barrier is provided consisting of an elastic, deformable material, which is fixated sealing at the reinforcement ring or at the shaft.

4. A constant velocity joint, as recited in claim 1, having an inner race, which is connected with a shaft when in operation, an outer race an outer race and a reinforcement ring that can be positively connected with the outer race, which encases the outer race torque-proof, wherein the length of the reinforcement ring in the axial direction of the joint is larger by approximately a factor of 1.5 to 2.5, in particular 1.75 to 2.0 than the length of the outer race in axial direction of the joint, whereby the reinforcement ring has a protruding, connection section for fastening a journal, and/or a preferably cylindrical sealing section extending in axial direction over the outer race for fastening a grease barrier and/or a sealing boot.

5. A constant velocity joint as recited in claim 1 having a journal that can be connected with the outer race for connecting the joint wherein the journal has, at least in sections, an outer contour corresponding to the inner contour of the reinforcement ring that transmits torque.

6. A constant velocity joint as recited in claim 1, wherein the reinforcement ring has at least one shoulder that extends approximately perpendicular to the longitudinal axis of the joint radially inward, which has a stop section for positioning the outer race.

7. A constant velocity joint as recited in claim 1, wherein the reinforcement ring is connected with journal by a firmly bonded material connection.

8. A constant velocity joint as recited in claim 1 having a grease barrier located in the reinforcement ring, wherein the grease barrier has an outer bead section preferably reinforced by a ring or a band, which is clinched into reinforcement ring.

9. A constant velocity joint as recited in claim 1, wherein the joint is a fixed joint, in particular a counter track joint that has a cage having balls guided in it between the inner race and the outer race for transmitting torque.

10. A constant velocity joint as recited in claim 1, wherein the components of the joint are configured for transmitting continuous torque of more than 400 Nm, in particular of more than 550 Nm.

11. A constant velocity joint as recited in claim 1, wherein the wall thicknesses at least of the reinforcement ring and/or the outer race are reduced in such a way that the weight of the inner race, the cage, the balls, the outer race and the reinforcement ring amounts to less than 1 kg, in particular less than approximately 750 g.

12. A constant velocity joint as recited in claim 1, wherein the operationally admissible angle of the outer race to the inner race is more than 30°, in particular approximately 45°.

13. A constant velocity joint as recited in claim 1, wherein the outer race is encased in sections by the shoulder section of the journal.

14. A drive shaft for a motor vehicle, in particular a lateral shaft, with two constant velocity joints, having respectively an inner race, an outer race, a cage having balls located between these and a reinforcement ring that can be positively connected with the outer race, at least one shaft pipe and, if necessary, a slip unit, wherein the joints are constructed in the same way, in particular, are identical, whereby each joint is associated with a journal that can be connected with the outer race and/or with the reinforcement ring for connecting the joint.

15. A drive shaft for a motor vehicle, as recited in claim 14, having two constant velocity joints, which respectively have an inner race, an outer race, a cage having balls located between them and a reinforcement ring that can be positively connected with the outer race, at least one shaft pipe and if necessary, a slip unit, wherein the total weight of the two joints together is smaller, in particular, smaller by a factor of approximately 5, than that of at least one shaft pipe with the—if necessary—slip unit.

16. A drive shaft for the front axle of a motor vehicle, as recited in claim 14, wherein the weight of the drive shaft is approximately 4 kg to approximately 5.5 kg.

17. A drive shaft for the rear axle of a motor vehicle, as recited in claim 14, wherein the weight of the drive shaft is approximately 5 kg to approximately 7 kg.

18. A drive train for a motor vehicle having at least one longitudinal shaft and at least two lateral shafts, that respectively have joints, in particular constant velocity joints as recited in claim 1, wherein all joints are constructed in the same way, in particular, are identical.
